(19) United States
(12) Patent Application Publication
(10) Pub. No.: US 2004/0250759 A1
(43) Pub. Date: Dec. 16, 2004

(54) Painting device

(76) Inventor: Makoto Ueno, Tagajo-shi (JP)

Correspondence Address: BURR & BROWN, PO BOX 7068, SYRACUSE, NY, 13261-7068, US

(21) Appl. No.: 10/479,926

(22) PCT Filed: Jun. 7, 2002
(86) PCT No.: PCT/JP02/05675

(30) Foreign Application Priority Data
Jun. 8, 2001 (JP) 2001-174259

(51) Int. Cl. B05C 5/00

(52) U.S. Cl. 118/300

(57) ABSTRACT

A painting device suitable to use for painting, for example, the body of a vehicle and capable of improving the spraying state of paint, comprising a painting device body (4) having a compressed air feed passage (2) for feeding compressed air and a paint feeding passage (3) for feeding the paint, a paint injection nozzle (5) installed in the painting device body and having an injection port for injecting the paint, and a needle valve (6) for opening and closing the injection port to regulate the injection amount of the paint, the needle valve (6) having a tip part (14) with reduced diameter toward a tip side positioned on the injection port (8) side further comprising a first linear part (28) having a specified length inside the paint injection nozzle (5) and provided continuously with the tip part (14).

### TECHNICAL FIELD

The present invention relates to a painting device suitable to use for painting, for example, a vehicle body or the like.

### BACKGROUND ART

For painting a body of a vehicle such as an automobile, there is usually employed a method in which compressed air and a paint are simultaneously injected to atomize the paint to thereby perform painting. A painting device called a spray gun is suitably used for performing the above painting.

A spray gun, which is generally shaped like a small pistol, includes a paint feeding portion for feeding a paint, a compressed air feeding portion for feeding compressed air, a paint injection nozzle serving as an injection port for the paint, a trigger portion for adjusting an amount of paint to be injected from the paint injection nozzle, and a spray gun main body to which those components are mounted.

Inserted in the interior of the paint injection nozzle is a bar-like valve (needle valve) whose one end is formed as a narrowed tip and whose other end is coupled to an elastic member such as a spring. The bar-like valve, which has an end portion formed as a narrowed tip, slides inside the paint injection nozzle to thereby open and close the injection port.

Further, since the elastic member is urged in a direction for closing the injection port, the slide movement of the needle valve is effected by operating the trigger portion to move the needle in a direction opposite to the urged direction thereof.

Thus, the injection port that has been closed is opened, allowing the paint fed from the paint feeding portion and the compressed air fed from the compressed air feeding portion to be injected from the injection port at the same time. Then, the paint is atomized by means of the compressed air, thus adhering to a surface to be painted. Due to the atomization of the paint, it is possible to obtain a painted surface that dries fast and is uniformly painted.

Incidentally, examples of the types of painting include block painting in which a surface to be painted is uniformly painted and gradation painting in which painting is performed in such a way that the boundary between the surface to be painted (newly painted surface) and a previously painted surface does not appear incongruous.

The gradation painting refers to a painting technique whereby painting is performed so as to blur the boundary between the surface to be newly painted and the previously painted surface for which additional painting is unnecessary because a previously applied paint remains thereon.

A highly skilled technique is required for an operator to perform the gradation painting with the spray gun described above.

This is because, with the spray gun described above, it is impossible to suitably adjust a balance among a flow rate of the compressed air, an injection port opening surface area, and the amount of the paint, upon starting the operation of the trigger portion. More specifically, although the injection rate of the compressed air is low immediately after starting the operation of the trigger portion, a predetermined amount of the paint is fed into the paint injection nozzle. As a result, the paint is injected as it is with its particle size being still large, that is, without being fully atomized. When the paint is injected without being fully atomized, this leads to such problems that a paint film becomes large in thickness or the paint does not easily adhere to a painting surface.

Further, in order to proactively avoid the above-mentioned problem, it is required to perform a step of blowing the paint to the surface to be painted after adjusting the injection amount of the paint by once pulling the trigger portion outside the painting surface.

However, performing the above step means that some paint is wastefully discarded. Naturally, the proportion of discarded paint increases as the surface to be painted becomes larger.

The present invention has been made in view of the above-mentioned problems, and has an object to provide a painting device capable of adjusting the spraying state of a paint in a favorable manner.

Further, another object of the present invention is to provide a painting device which allows painting to be performed without wasting the paint and by means of simple operation.

### DISCLOSURE OF THE INVENTION

A painting device according to the present invention is a painting device in which a paint is atomized by mixing compressed air and the paint together before being applied to a surface to be painted.

The painting device according to the present invention includes: a painting device main body provided with a compressed air feeding passage for feeding the compressed air, and a paint feeding passage for feeding the paint; a paint injection nozzle provided to the painting device main body and having an injection port for injecting the paint; and an adjusting means for adjusting an injection amount of the paint by opening and closing the injection port.

Further, the adjusting means is a needle that is slidable in an interior of the paint injection nozzle. The amount of paint injected from the paint injection nozzle can be adjusted by the needle sliding in the interior of the paint injection nozzle. Further, such a needle is also called a needle valve serving as a valve for adjusting a flow rate of the paint.

In addition, the needle valve becomes gradually narrower on its tip side, enabling an extremely fine adjustment of the flow rate.

Further, the needle valve has a narrowed tip portion located on an injection port side and at least one linear portion provided on an interior side of the paint injection nozzle, the linear portion having a predetermined length and being provided continuous to the tip portion.

Due to the provision of the linear portion, it is possible to increase an operation amount required for fully opening the injection port. Further, a moving amount of the needle valve during small-amount spraying at the time of operating the trigger portion, that is, the total requisite operation amount of the trigger portion during small-amount spraying of the paint, can be increased, thus facilitating the fine adjustment of the spray amount of paint.

Further, a length of a generatrix of the tip portion may be set as 0.5 mm, and a tip angle thereof may be set within a range of 80 to 85 degrees.

In addition, the linear portion is preferably a tapered portion whose diameter increases from the injection port toward a proximal end side of the paint injection nozzle.

This is because, when the linear portion is thus formed as a tapered portion that increases in diameter from the injection port toward the paint injection nozzle, the injection port is gradually opened as the trigger portion is operated, thereby restricting the injection amount of the paint as well. That is, it is possible to prevent a large amount of paint from being injected all at once.

Note that, while the most suitable taper angle for the tapered portion is 3 degrees, a taper angle within a range of 2 to 4 degrees is sufficiently suitable. In addition, a taper ratio of the tapered portion may be set within a range of 0.30 to 0.35.

Further, because it allows the injection port to be opened gradually, the paint injection nozzle of the present invention can be suitably used for gradation painting in which painting is performed such that a boundary between a surface to be painted and a previously painted surface does not become conspicuous.

For instance, when performing painting to a damaged location such as a blemish and a large dent formed on an automobile body, it is necessary to determine which color shade and which film thickness should be selected for performing painting with respect to a previously painted surface located in the periphery of the damaged location. Naturally, painting is performed at a large paint film thickness on a surface to be painted which is the damaged location, whereas painting is performed at a small paint film thickness on the boundary between the surface to be painted and the previously painted surface.

In this case, with conventional spray guns, a paint having a large particle size is injected immediately after operating the trigger portion. This is because, while the injection port that has been fully closed is burst open all of a sudden upon operating the trigger portion, the compressed air is not fed to the injection port simultaneously with the opening of the injection port, with the result that the amount of the compressed air fed immediately after operating the trigger portion is usually small.

Therefore, the paint is not fully atomized and injected as it is in the form of particles with a large particle size. Then, the paint particles with a large particle size are applied even to a location where painting needs to be performed such that the film thickness gradually increases from small to large, such as the boundary between the surface to be painted and the previously painted surface, thereby causing the paint film to become thick.

However, with the painting device of the present invention, due to the tapered portion provided continuous to the tip of the needle, the air and paint can be fed in amounts corresponding to a fed pressure even at a time immediately after the opening of the injection port.

Therefore, an adjustment can be effected such that painting can be performed on the surface to be painted such that a thick paint film is formed thereon and also a thin paint film is formed on the previously painted surface.

Further, according to the present invention, a first tapered portion, a second tapered portion, and a third tapered portion are continuously provided with the injection port as an end portion, in predetermined positions of an inner wall of the paint injection nozzle along which the needle slides.

The first tapered portion is formed as a tapered portion whose diameter decreases from the injection port toward the interior of the paint injection nozzle. Also, the second tapered portion is formed as a tapered portion whose diameter increases from a boundary between the second tapered portion and the first tapered portion toward the interior of the paint injection nozzle. Further, the third tapered portion is formed as a tapered portion whose diameter increases from a boundary between the third tapered portion and the second tapered portion toward the interior of the paint injection nozzle.

The amount of the air and the amount of the paint can be freely adjusted by adjusting a taper angle of the second tapered portion and a taper angle of the linear portion of the needle. For instance, when the taper angle of the linear portion corresponding to the second tapered portion is made smaller than the taper angle of the second tapered portion, the air gap between the second tapered portion and linear portion becomes larger as the needle valve slides toward the interior of the paint injection nozzle, thereby allowing a relatively large amount of paint to be injected.

Thus, it is preferable that the taper angle of the linear portion be set according to the air pressure of the compressed air and property of the paint.

Further, when the taper angle of the linear portion is made larger than the taper angle of the second tapered portion, a relatively large amount of air is injected as the injection port is opened. Because the amount of the paint is thus restricted in a relative relationship with the feed amount of the compressed air, the paint is injected in a finely pulverized form with sufficient air amount and pressure even when air is injected in air pressure and amount that are conventionally employed. That is, even in the case of a low-pressure painting device for injecting air at a low pressure, the paint can be atomized in substantially the same manner as in the case where it is atomized by using a high-pressure painting device.

Further, the needle used in the painting device of the present invention is urged in a direction for closing the injection port by means of an elastic member. The elastic member is constructed from a combination of plural elastic members having different elastic moduli. As the elastic member, a spring may be suitably used. Note that the spring used in the present invention is a coil spring, which is constructed from a combination of a coil spring having a high spring modulus and a coil spring having a low spring modulus.

Further, the needle operates in association with the trigger portion used for manipulating the amounts of the paint and the compressed air to be injected from the injection port of the paint injection nozzle provided to the barrel-like painting device main body. Of course, the elastic member that is coupled to the needle also operates in association with the movement of the trigger portion.

According to the present invention, the coil spring is composed of a coil spring having a high spring modulus and a coil spring having a low spring modulus which are coupled to each other, thereby naturally regulating a force with which the trigger portion is pulled. It is the coil spring having a low spring modulus to which a force is first applied and which is subjected to a smaller compression, and as a larger force is applied, the coil spring having a high spring modulus also begins to be compressed.

Therefore, the injection operation can be performed in stages. For example, only the compressed air is injected in the stage where the coil spring having a low spring modulus is compressed first. Then, in the stage where both the coil spring having a low spring modulus and the coil spring having a high spring modulus are subject to compression, the compressed air and the paint are injected as appropriate.

Further, in the stage where both the coil spring having a high spring modulus and the coil spring having a low spring modulus are fully compressed, the maximum amounts of the compressed air and the paint are injected. The injection pattern such as one described above may be employed.

That is, a plurality of coil springs having different spring moduli are coupled to each other, whereby the injection level of the paint can be changed in stages.

Further, the coil spring having a high spring modulus and the coil spring having a low spring modulus are coupled to each other, whereby it is possible to prevent the paint from being injected at a low pressure that is not higher than a predetermined value and applied to the surface to be painted in an incompletely atomized state.

According to the painting device of the present invention, there can be provided a painting device which enables an improvement in the spraying state of a paint.

Further, according to the painting device of the present invention, there can be provided a painting device which allows painting to be performed without wasting the paint and by means of simple operation.

### BRIEF DESCRIPTION OF THE DRAWINGS

FIG. 1 is a cross sectional view of a spray gun according to an embodiment of the present invention.

FIG. 2 is an enlarged cross sectional view of a main portion of the spray gun according to the embodiment.

FIG. 3 is an enlarged cross sectional view of a main portion of a paint injection nozzle according to the embodiment.

FIG. 4 is an enlarged view of a main portion of a needle valve according to the embodiment.

FIG. 5 is a partial enlarged cross sectional view showing the main portions of the paint injection nozzle and the needle valve according to the embodiment.

FIG. 6 is a front view of a coil spring according to the embodiment.

FIG. 7 is a cross sectional view showing a state where a trigger portion of the spray gun is operated according to the embodiment.

FIG. 8 is a cross sectional view showing a state where the trigger portion of the spray gun is operated according to the embodiment.

FIG. 9 is a diagram showing a painting surface in mesh plot.

FIG. 10 is a chart showing a graph illustrating results of measurement on a thickness of a paint film formed by using a conventional spray gun.

FIG. 11 is a chart showing a graph illustrating results of determination of a thickness of a paint film formed by using the spray gun according to the embodiment.

FIG. 12 is a chart showing a graph illustrating a comparison of a paint film thickness between the spray gun according to the embodiment and the conventional spray gun.

FIG. 13 is an enlarged view of a main portion of a needle valve of the prior art.

FIG. 14 is a partial enlarged cross sectional view showing main portions of a paint injection nozzle and the needle valve of the prior art.

### BEST MODE FOR CARRYING OUT THE INVENTION

Hereinbelow, an embodiment of the present invention is described in detail based on the drawings.

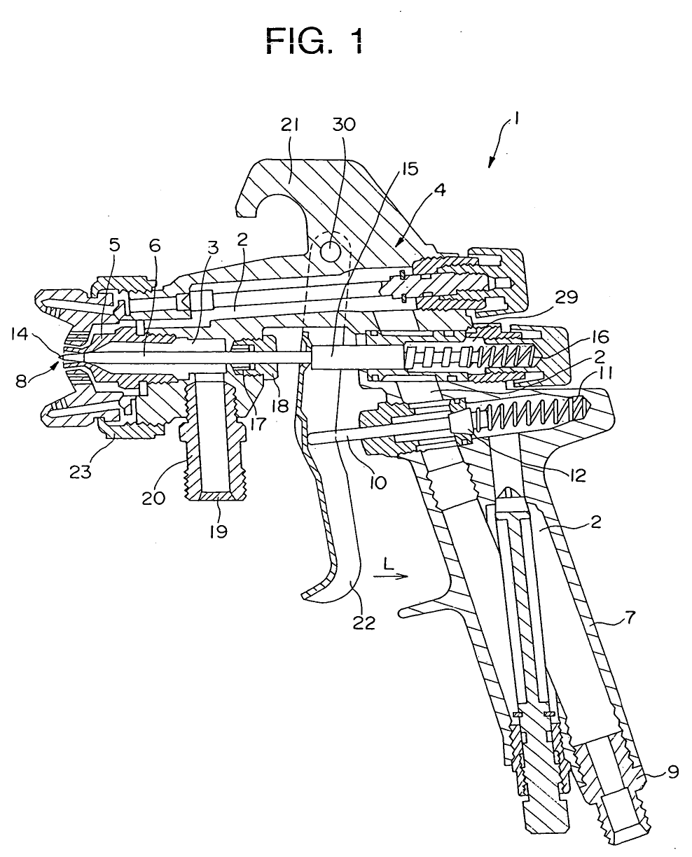

First, a construction of a painting device (spray gun) according to this embodiment is described. FIG. 1 is a cross sectional view showing a spray gun 1 as a whole. With the spray gun 1 according to the present invention, compressed air and a paint are mixed together to atomize the paint with the compressed air, and the atomized paint is applied to a surface to be painted.

The spray gun 1 according to this embodiment includes: a spray gun main body 4 provided with a compressed air feeding passage 2 for feeding compressed air and a paint feeding passage 3 for feeding a paint; a paint injection nozzle 5 provided in the spray gun main body 4 and having an injection port 8 for injecting the paint; and a needle valve 6 for opening and closing the injection port 8 to adjust an injection amount of the paint.

The spray gun 1, which is shaped like a small pistol, includes a grip portion 7 for gripping the spray gun 1 and a barrel portion 21 provided continuous to the grip portion 7 and having the injection port 8 for injecting the paint and the compressed air.

Further, provided in the interior of the spray gun main body 4 is the compressed air feeding passage 2 through which the compressed air passes from a lower portion of the grip portion 7 to the injection port 8.

Further, provided in the lower portion of the grip portion 7 is an air nipple 9 that connects to a compressed air feeding source. In addition, the compressed air feeding passage 2 is provided so as to extend from the air nipple 9 toward an upper portion of the grip portion 7. Provided near the boundary between the grip portion 7 and the barrel portion 21 is a bar-like air valve 10 for opening and closing the compressed air feeding passage 2, the air valve 10 being located substantially perpendicular to the grip portion 7.

Further, the air valve 10 has a coil spring 11 at its proximal end, the coil spring 11 urging the air valve 10 in a direction for closing the compressed air feeding passage 2.

Furthermore, provided near the middle of the air valve 10 is an air packing 12 for effecting opening and closing of the compressed air feeding passage 2 with reliability. Use of an elastic member such as resin for the air packing 12 allows intrusion and leakage of the compressed air to be blocked with reliability upon closing of the compressed air feeding passage 2 by the air valve 7.

Further, arranged above (in the stage above) the air valve 10 are the needle valve 6 for adjusting the paint injection and the paint injection nozzle 5.,

The needle valve 6 has a narrowed tip portion 14 provided at one end on the injection port 8 side and a coil spring 16 provided at the other end through the intermediation of a needle valve guide 15 that controls the movement of the needle valve 6. The coil spring 16 is urged in a direction for closing the injection port 8. Further, arranged forward of the needle valve guide 15 is a needle packing 17 for sealing against paint leakage which is pressed in position by a packing adjusting screw 18. The packing adjusting screw 18 is fastened and screwed in position with a force suitable for preventing paint leakage and ensuring smooth operation of the needle valve 6.

Further, located near the middle of the needle valve 6 is a paint guide passage 20 attached with a paint joint 19 that connects to a paint feeding source.

Further, the respective end portions of the needle valve guide 15 and the air valve 10 on the injection port 8 side abut against a trigger portion 22 having a rotation center 30 in the barrel portion 21 and provided substantially parallel to the grip portion 7. Accordingly, when the trigger portion 22 is pulled toward the grip portion 7 side, the coil spring 11 provided to the air valve 10 and the coil spring 16 provided to the needle valve 6 are compressed.

When the coil spring 11 provided to the air valve 10 is thus compressed, the air packing 12 provided to the air valve 10 moves toward the coil spring 11 side, causing the compressed air feeding passage 2 to open. Then, the compressed air is fed to reach the injection port 8 through the compressed air feeding passage 2 provided in the barrel portion 21.

Further, when the coil spring 16 provided in the end portion of the needle valve 6 is compressed, the needle valve 6 is slidingly inserted into the tubular needle valve guide 15.

This operation causes the needle valve 6 that has previously closed the injection port 8 to be withdrawn to the inner portion of the injection port 8, with the result that the injection port 8 is opened to allow injection of the paint.

Note that the needle valve 6 is designed to inject compressed air while moving several mm ahead of the air valve 10, so that the compressed air is fed only slightly before the paint injection.

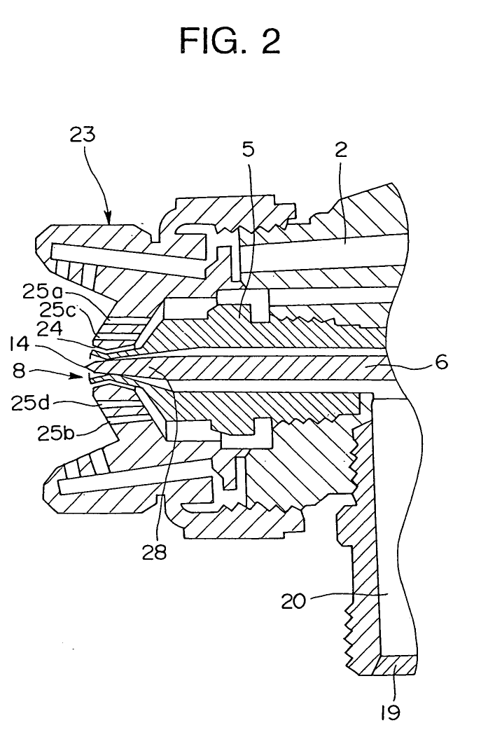

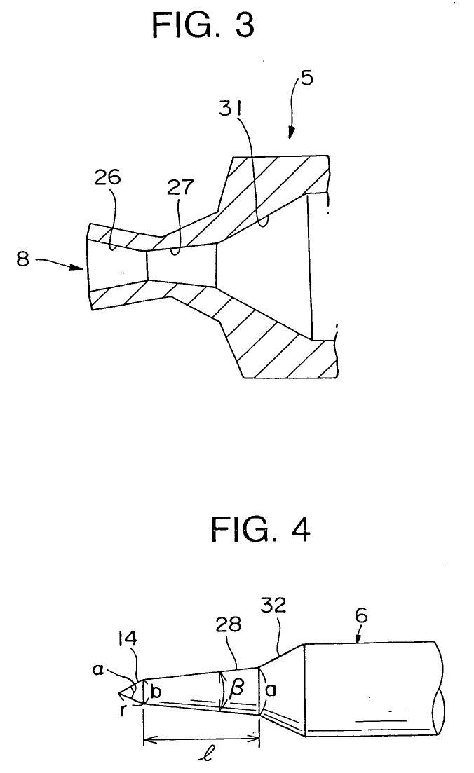

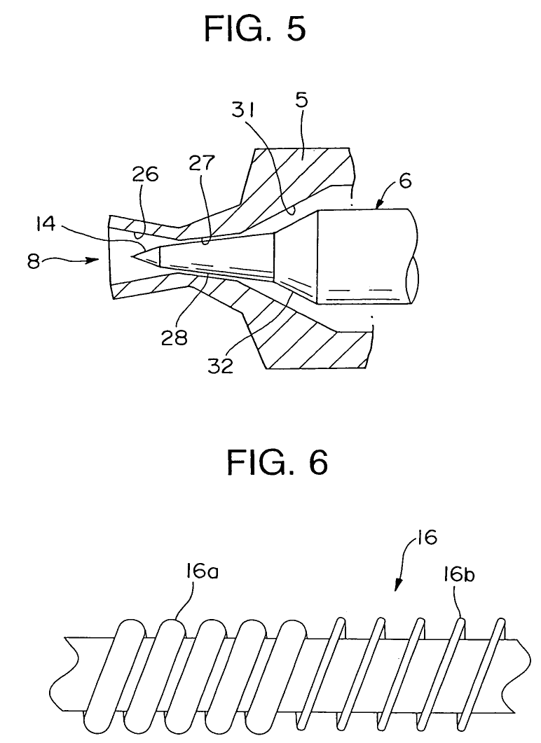

Next, a detailed description is given of a tip structure of the spray gun 1 of this embodiment. FIG. 2 is an enlarged cross sectional view showing a tip of the spray gun 1, and FIG. 3 is an enlarged cross sectional view showing the paint injection nozzle 5 of the spray gun 1. In addition, FIG. 4 is an enlarged view showing a tip of the needle valve 6 of the spray gun 1, and FIG. 5 is a partial enlarged cross sectional view showing the tip portion 14 in a state where the needle valve 6 is fitted in the paint injection nozzle 5 of the spray gun 1. Note that, for convenience of description, the components described with reference to FIG. 1 are described by attaching the same symbols thereto.

First, the tip structure of the spray gun 1 is described based on FIG. 2. In the spray gun 1, an air cap 23 is threadingly engaged with the injection port 8. The air cap 23 has slits 25 composed of a plurality of narrow holes which are provided around a through hole 24 provided in the center thereof. Mainly the paint is injected from the through hole 24, while the compressed air is injected from the slits 25 provided around the through hole 24.

The paint is dispersed with the injected compressed air. Spraying a liquid to obtain fine particles in this way is referred to as atomization.

Further, the paint injection nozzle 5 is located in the interior of the through hole 24. As shown in FIG. 3, the paint injection nozzle 5 is composed of a first tapered portion 26 whose diameter decreases as it extends from the injection port 8 toward the inner portion of the paint injection nozzle 5, a second tapered portion 27 whose diameter increases as it extends further inward from the first tapered portion 26, and a third tapered portion 31 whose diameter increases as it extends further inward from the second tapered portion 27.

Further, the needle valve 6 which is a bar-like valve shown in FIG. 4 is inserted in the interior of the paint injection nozzle 5. The needle valve 6 is composed of a narrowed tip portion 14, a first linear portion 28 continuous to the tip portion 14, and a second linear portion 32 continuous to the first linear portion 28. The first linear portion 28 has a taper angle that is adapted to the second linear portion 27, forming a tapered portion whose diameter increases as it extends from the injection portion 8 constituting the tip portion of the paint injection nozzle 5 toward the proximal end side of the paint injection nozzle 5.

In addition, the second linear portion 32 has a taper angle that is adapted to the third tapered portion 31 and, similarly to the first linear portion 28, increases in diameter as it extends from the injection port 8 toward the inner portion of the paint injection nozzle 5.

Further, it is preferable that the tip portion 14 according to this embodiment have a conical configuration, with a length r of the generatrix of the tip portion 14 which constitutes the tip portion 14 being set as 0.5 mm and a tip angle α thereof being set within a range of 80 to 85 degrees. A taper angle of 83 degrees, in particular, enables the injection state of the paint to be remarkably improved.

While favorable effects can be attained if a taper angle β0 of the first linear portion 28 is within a range of 2 to 4 degrees, the most favorable effects can be achieved if β=3 degrees.

In addition, a taper ratio of the first linear portion 28 is preferably set within a range of 0.30 to 0.35. The taper ratio represents a value obtained by dividing a difference between a diameter a on the larger diameter side of the first linear portion 28 of the needle valve 6 and a diameter b on the smaller diameter side thereof by a length (taper length) l of the first linear portion 28.

Further, as shown in FIGS. 1, 6, 7, and 8, the needle valve 6 according to this embodiment is constructed of a combination of a first coil spring 16a and a second coil spring 16b that have mutually different spring moduli.

Note that, in this embodiment, the first coil spring 16a has a spring modulus lower than that of the second coil spring 16b. However, the first coil spring 16a may be formed as a coil spring having a higher spring modulus than the second coil spring 16b, and of course, the reverse may also be possible.

Further, the first coil spring 16a is in contact with the needle valve guide 15, and the second coil spring 16b connects to the first coil spring 16a at one end and abuts against an inner wall of a guide chamber 29 at the other end. The guide chamber 29 receives the proximal end side of the needle valve guide 15 and the first and second coil springs 16a and 16b.

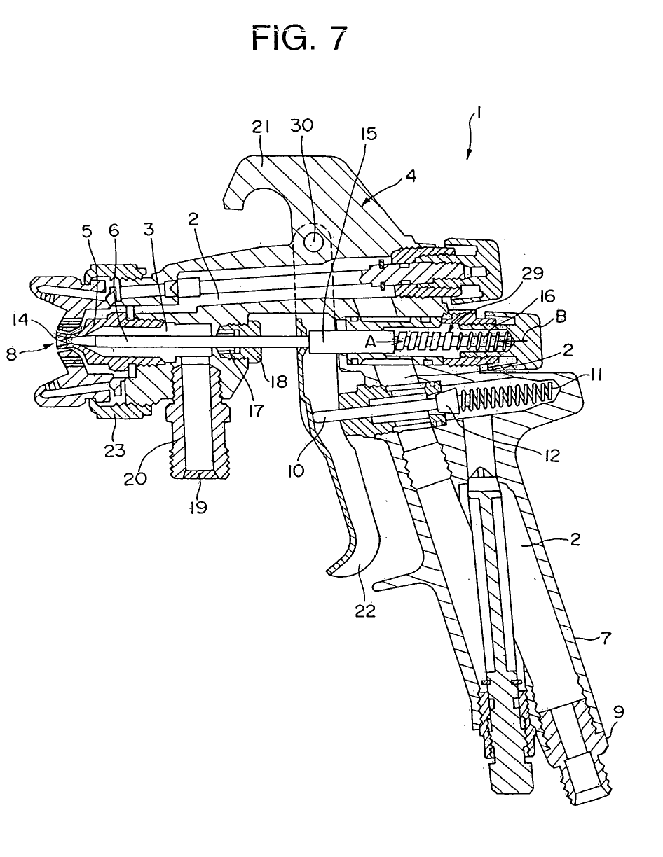

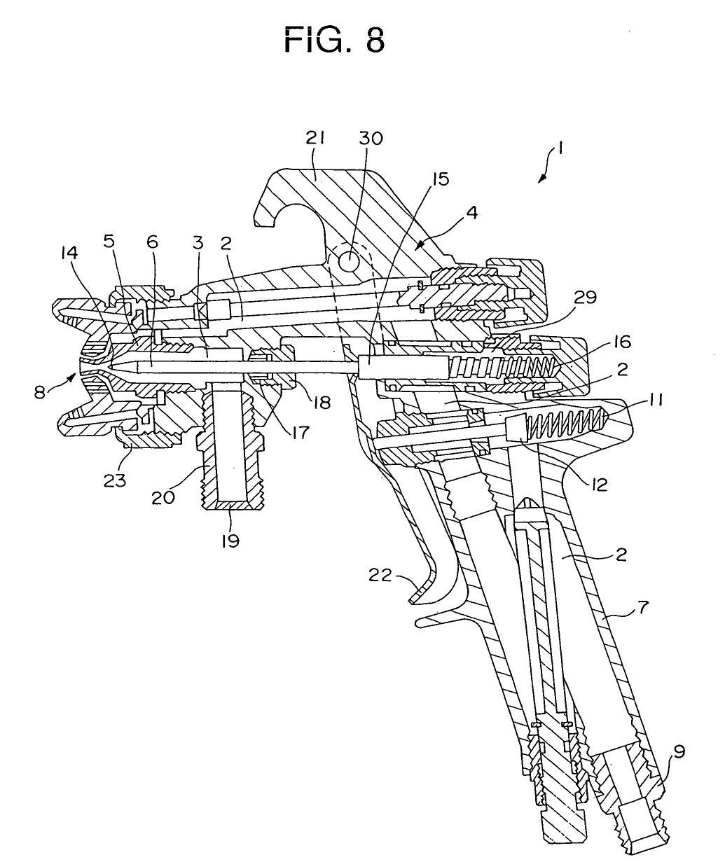

When, as shown in FIG. 7, the trigger portion 22 is pulled with a force A, the first coil spring 16a is pressed by the needle valve guide 15 that is caused to slide rearward. Further, in accordance with the sliding of the needle valve guide 15, the force A is also transmitted to the second coil spring 16b that abuts against the inner wall of the guide chamber 29. Then, the force A is transmitted to the inner wall of the guide chamber 29, causing a resultant reaction force B to act on the second coil spring 16b. As a result, both the first coil spring 16a and the second coil spring 16b are compressed. At this time, while the same force acts on the first coil spring 16a and the second coil spring 16b, due to a difference in elastic modulus therebetween, there is a difference in compressibility ratio (compressed length) between the first coil spring 16a and the second coil spring 16b during the operation of the trigger portion 22 up to the final stage.

That is, the coil spring 16 according to this embodiment may undergo three stages of operation: a first stage of compressing mainly the first coil spring 16a by pulling the trigger portion 22; a second stage of compressing mainly the second coil spring 16b by pulling the trigger portion 22 in addition to the compression of the first spring coil 16a; and a third stage (final stage) of fully compressing both the first coil spring 16a and the second coil spring 16b.

Therefore, it is possible to perform an operation in which: only the compressed air is injected when the first coil spring 16a is mainly compressed; the compressed air and the paint are injected in regulated, predetermined amounts when the second coil spring 16b are partway compressed in addition to the compression of the first coil spring 16a; and the compressed air and the paint are injected in their maximum amounts when the first coil spring 16a and the second coil spring 16b are fully compressed.

Thus, the operation of the trigger portion 22 from the initial stage to the halfway stage may be appropriately referred to as the so-called semi-clutch state in which fine adjustments can be effected on the needle valve 6 with a relatively small force. Due to the existence of this state, it is possible to easily perform painting in such a way to blur the boundary between a surface to be painted and a previously painted surface.

As the trigger portion 22 is pulled, the needle valve 6 accordingly slides into the needle valve guide 15, thereby opening the injection port 8 of the paint injection nozzle 5.

In more detail, by operating the trigger portion 22, mainly the first coil spring 16a is compressed substantially simultaneously with the opening of the air valve 10 and the injection of the compressed air as described above. At this time, the needle valve 6 slides to enter the interior of the paint injection nozzle 5.

Then, although previously fittingly engaged with each other as appropriate, the respective tapers of the first linear portion (tapered portion) 28 of the needle valve 6 and the second tapered portion 27 of the paint injection nozzle 5 shift out of the fitting engagement with each other, producing a slight clearance between the respective tapers. At this time, the tip portion 14 of the tapered portion 28 of the needle valve 6 is located within the first tapered portion 26 of the paint injection nozzle 5.

Then, when the needle valve 6 and the first coil spring 16a are in the above-described state, only the compressed air is injected from the injection port 8.

When the trigger portion 22 is further operated and the compression of the second coil spring 16b also begins, the needle valve 6 slides further into the inner portion of the needle valve guide 15 arranged in the inner portion of the paint injection nozzle 5. This causes the clearance between the tapered portion 28 and the second tapered portion 27 to become wider. In this state, appropriate amounts of the paint and the compressed air are injected from the injection port 8.

In addition, when the first coil spring 16a and the second coil spring 16b are fully compressed, the tip portion 14 of the needle is fully received inside the paint injection nozzle 5.

At this time, both the compressed air and the paint are injected in their maximum amounts from the injection port 8.

Next, a description is made on the principle of injection using the spray gun 1 according to this embodiment described above together with a description of operation.

First, when performing painting by using the spray gun 1 according to this embodiment, an operator holds the grip portion 7 while directing the injection port 8 to a surface to be painted, making himself ready to perform the painting. At this time, the injection port 8 is located over the boundary between a previously painted surface and the surface to be painted.

Then, as shown in FIG. 7, by pulling the trigger portion 22 toward the grip portion 7 side, the needle valve guide 15 is brought into abutment against the trigger portion 22. Then, as shown in FIG. 8, the needle valve 6 begins to slide upon the abutment of the needle valve guide 15 against the trigger portion 22, to advance into the inner portion of the needle valve guide 15. That is, the needle valve 6 that has previously closed the injection port 8 is withdrawn into the inner portion of the barrel portion 21. Accordingly, the previously closed injection port 8 is opened.

Further, paint in the paint guide passage 20 is injected from the injection port 8. At this time, as described above, the compressed air is injected slightly earlier. Thus, the paint is atomized with a sufficient amount of compressed air upon injection.

Furthermore, as shown in FIG. 5, with the paint injection nozzle 5 and the needle valve 6 of this embodiment, the second tapered portion 27 of the paint injection nozzle 5 and the tapered portion 28 of the needle valve 6 have substantially the same taper angle. Therefore, even when the needle valve 6 is withdrawn into the inner portion of the paint injection nozzle 5, the gap between the second tapered portion 27 and the tapered portion 28 is maintained substantially constant.

Therefore, although the compressed air is initially fed in a small amount from the slits 25 provided in the air cap 23, the paint can be injected in an amount commensurate with the flow rate of the compressed air. Thus, unlike in the prior art, there is no fear of the paint being injected as it is in the form of large particles without being fully atomized immediately after the injection.

Further, the inventors of the present invention have conducted an experiment to confirm the above-described effects. The content and the results of the experiment are described below.

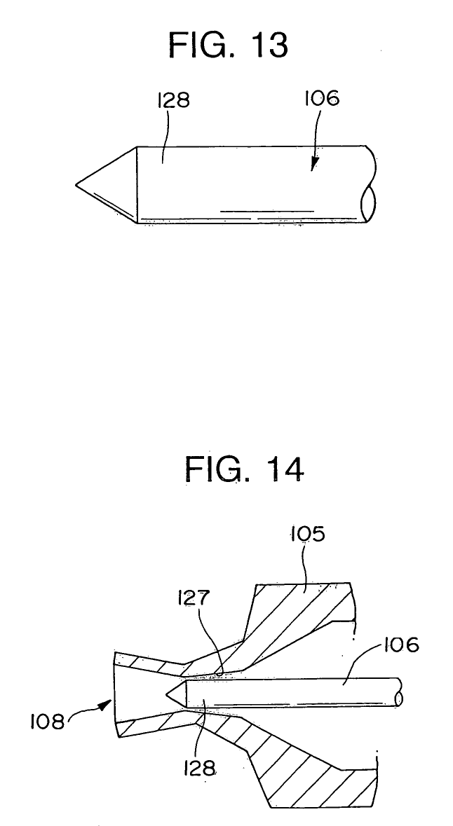

Note that, for comparison of the test results between the spray gun 1 of this embodiment and a conventional spray gun, a spray gun shown in FIG. 13, to which a needle valve 106 of W-88 (manufactured by IWATA Corporation) is attached, is used as the conventional spray gun. In addition, used as a sample in the present experiment is a generally used paint obtained by mixing a curing agent and a pigment and diluting the resultant mixture with thinner.

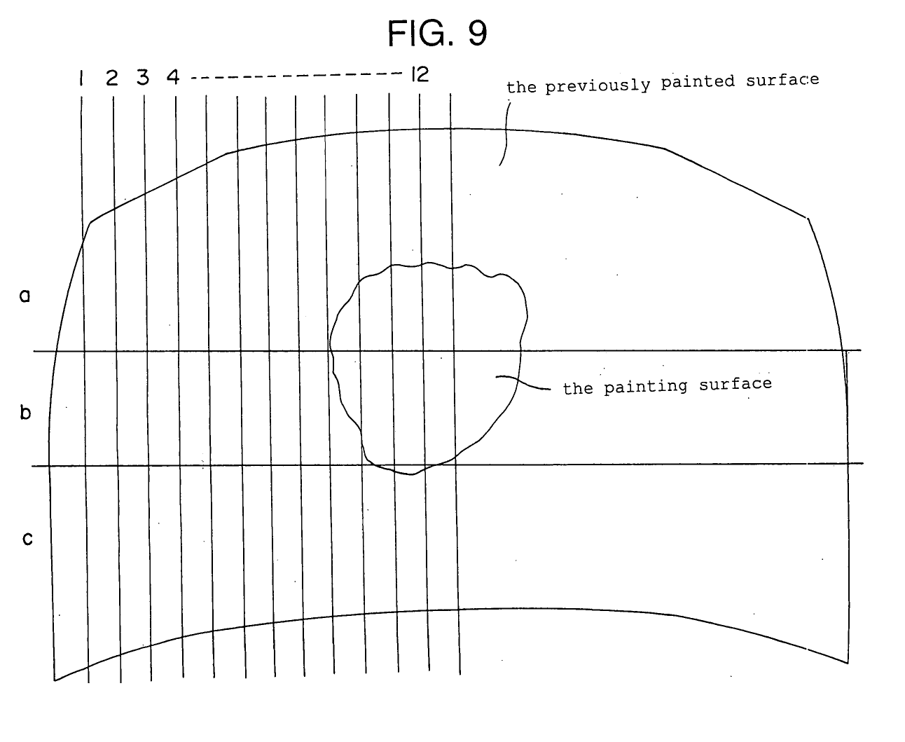

The present experiment is an experiment for measuring a film thickness of a paint applied onto a painting surface. First, as shown in FIG. 9, the half of the painting surface is split into meshes of three columns by twelve rows. Then, numerals 1 to 12 indicating the positions of the respective meshes are attached to the above-mentioned painting surface. Note that the width of the mesh row is set to 4 cm.

Next, the paint is injected while setting an air pressure under which the compressed air is fed as 0.8 kg/cm² and a distance from the painting surface to the spray gun 1 as 15 cm. At this time, the injection port 8 is moved at a right angle with respect to the painting surface. Note that, of the meshes split by three columns, a, b, and c, the injection is performed on the mesh in the second column (b) in the present experiment. Further, the injection using the spray gun is started at the mesh No. 1, and the spray gun is moved rightward while pulling the trigger portion with a gradually increasing force (while increasing the operation amount thereof), finishing the injection at the mesh No. 12.

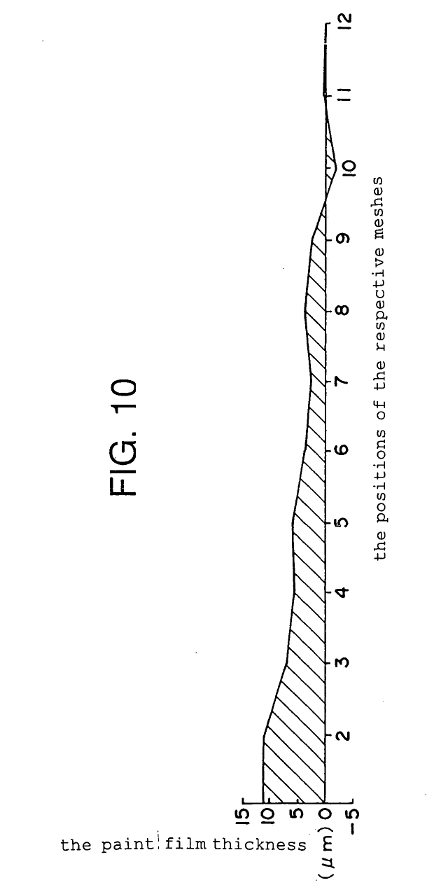

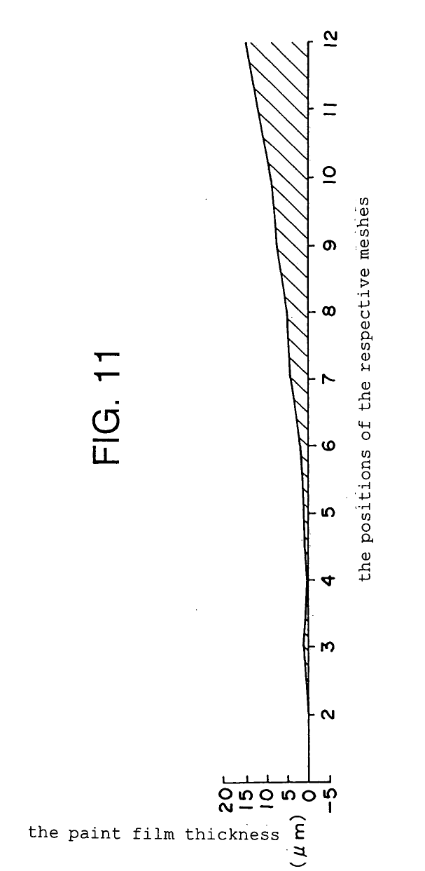

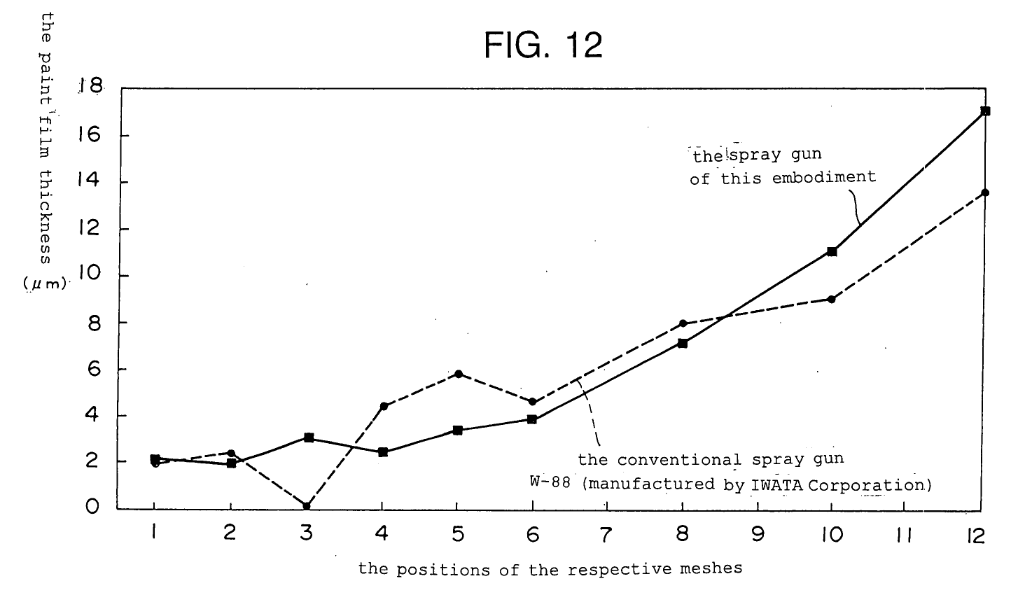

Then, the film thickness of the paint applied on the painting surface is measured, the results of which are shown in FIGS. 10 to 12. Note that FIG. 10 is a graph indicating changes in the film thickness when the injection is performed using the conventional spray gun, FIG. 11 is a graph indicating changes in the film thickness when the injection is performed using the spray gun 1 according to this embodiment, and FIG. 12 is a graph showing a comparison between a film thickness obtained by painting with the conventional spray gun and a film thickness obtained by painting with the spray gun 1 of this embodiment.

In the graphs shown in FIGS. 10 to 12, the vertical axis represents the paint film thickness (μm) and the horizontal axis represents the mesh number (paint injection position). Indicated by the solid line are the measurement results obtained with the spray gun 1 of this embodiment, and indicated by the broken line are the measurement results obtained with the conventional spray gun.

Those graphs reveal that, in general, the film thickness tends to increase gradually during the period from the start to the end of injection in the case of both the spray guns.

However, with the spray gun 1 according to this embodiment, the film thickness increases in stages as the paint position shifts from Mesh 1, Mesh 2, Mesh 3, and so forth.

In contrast, with the conventional spray gun, while the film thickness is about 2 μm in Mesh 1 and in Mesh 2, the film has hardly any thickness in Mesh 3 (0 μm). Then, the film thickness in Mesh 4 is about 6 μm.

That is, with the conventional spray gun, a large amount of paint is injected immediately after the injection and thereafter no paint is injected for a temporary period. When the injection is further continued, the injection amount increases again.

This is due to a difference in injection amount between the paint and the compressed air, which is in turn attributable to the configuration of the needle valve for adjusting the paint injection amount.

Although the needle valve 106 used in the conventional spray gun has a narrowed tip, a linear portion 128 of the needle valve 106, which is continuous from the tip, is formed to have the same diameter up to the proximal end of the needle valve 106.

Thus, when, as shown in FIG. 14, the needle valve 106 slides to the inner portion of a paint injection nozzle 105, the gap formed between a second tapered portion 127, whose diameter increases as it extends toward the inner portion of the paint injection nozzle 105, and the linear portion 128 suddenly widens. Therefore, upon starting the paint injection, an injection port 108 of the paint injection nozzle 105 is burst open all of a sudden. Thus, the paint is injected in an amount not commensurate with the feed amount of the compressed air. Therefore, the paint is applied to the painting surface without being sufficiently atomized. Accordingly, the paint film obtained immediately after the injection becomes thick, and moreover the paint remaining uninjected near the injection port 108 is rapidly consumed, with the result that the injection paint becomes lost temporarily and no paint film is formed in the meantime (Mesh 3). Further, the paint fed from the paint feeding source side immediately after this period is injected in bulk all at once, and thus the paint film rapidly increases in thickness (Mesh 4).

On the other hand, in the needle valve 6 used in the spray gun 1 of this embodiment, the tapered portion 28, whose diameter increases as it extends toward the inner portion of the paint injection nozzle 5, is formed also in the first linear portion 28 as in the second tapered portion 27. Therefore, the gap between the second tapered portion 27 and the tapered portion 28 widens gradually. This means that the paint is gradually fed into the gap.

Thus, with the spray gun 1 of this embodiment, even when the flow rate of the compressed air is small immediately after pulling the trigger portion 22, the injection amount of the paint is adjusted due to the air gap formed between the paint and the second tapered portion 27 and the tapered portion 28, whereby the paint is sufficiently atomized. That is, the spray gun 1 of this embodiment allows a sufficiently atomized paint to be injected, albeit in a small injection amount, in the initial operation stage (operation involving no firm gripping) of the trigger portion 22.

Further, the spray gun 1 can prevent the paint film from being formed at a large thickness even immediately after the paint injection.

Due to the advantages mentioned above, according to the spray gun 1 of this embodiment, it is extremely easy to perform gradation painting in which the boundary between a previously painted surface and a surface to be painted is blurred. That is, due to the long stroke in the initial operation stage, the paint is always fully atomized, making it possible to inject finely atomized paint.

Further, in the spray gun 1 of this embodiment, the needle valve 6 is urged by the coil spring 16, with the coil spring 16 being constructed from a combination of plural springs having mutually different spring moduli (elastic moduli). This arrangement facilitates the operation of gradually changing the injection amount by pulling the trigger portion 22.

In addition, when operating the trigger portion 22, the trigger portion 22 maybe operated in stages. That is, by combining the plural coil springs having different spring moduli to urge the needle valve 6, the injection pattern can be changed in a plurality of stages. Of course, by increasing the number of types of coil springs to be combined together, it is possible to accordingly achieve a wider variety of injection patterns.

Further, the fact that the spray gun 1 can be operated in stages means that, in operating the trigger portion 22, the gripping force that needs to be applied by the operator is increased in stages. Accordingly, the operator can reliably recognize changes in the operation stages by the way he or she applies a gripping force. Thus, when, for example, the spray gun 1 is set such that a small amount of paint is atomized only in the initial operation stage, the operator can easily recognize an operation amount suitable for gradation painting while operating the spray gun 1.

Note that instead of the coil spring, there may be used a leaf spring or some other elastic member such as rubber. Further, as the elastic member, members having the same elastic modulus may be connected to each other while changing the respective quantities of those members stepwise, thereby obtaining the same function as that achieved by combining members having different elastic moduli.

Further, according to the spray gun 1 of this embodiment, fine adjustment can be effected on the injection amount of paint by operating the trigger portion 22. Therefore, there is no need to perform idle blowing once before starting the painting in order to perform adjustment of the paint injection amount.

Accordingly, there is no need to perform idle blowing of paint, making it possible to achieve a reduction in painting cost and an improvement in painting efficiency.

By using the spray gun 1 according to this embodiment described above, the operator can easily perform painting, in particular graduation painting, of a surface to be painted without acquiring an advanced technique therefor.

Note that, while the painting device of the present invention may be implemented in a variety of ways, such as by combining the painting device of the present invention with a main body of an automatic low-pressure painting device that is remotely controlled or by combining the painting device of the present invention with a manual spray gun, in this embodiment, the description is directed to the case where the painting device is the manual spray gun.

Further, while the painting device of the present invention is suitably used for vehicle repair, the painting device may also be applied for painting a wall surface or the like of a building.

It is to be understood that the present invention is not limited to the embodiment described above, and various modifications may be made by those skilled in the art without departing from the gist of the present invention as described in the claims.

1. A painting device in which a paint is atomized by mixing a compressed air and the paint together before being applied to a surface to be painted, the painting device comprising:
a painting device main body provided with a compressed air feeding passage for feeding the compressed air, and a paint feeding passage for feeding the paint;
a paint injection nozzle provided to the painting device main body and having an injection port for injecting the paint; and
an adjusting means for adjusting an injection amount of the paint by opening and closing the injection port,
the painting device being characterized in that the adjusting means is a needle valve that is slidable in an interior of the paint injection nozzle, the needle valve having a narrowed tip portion located on a side of the injection port and at least one linear portion provided on an interior side of the paint injection nozzle, the linear portion being continuous to the tip portion and having a predetermined length.

2. A painting device according to claim 1, characterized in that the linear portion is a tapered portion whose diameter increases from the injection port toward an inner portion of the paint injection nozzle.

3. A painting device according to claim 2, characterized in that a taper angle of the tapered portion is within a range of 2 to 4 degrees.

4. A painting device according to claim 2, characterized in that a taper ratio of the tapered portion is within a range of 0.30 to 0.35.

5. A painting device according to claim 1, characterized in that a length of a generatrix of the tip portion is 0.5 mm.

6. A painting device according to claim 1, characterized in that a tip angle of the tip portion is within a range of 80 to 85 degrees.

7. A painting device according to claim 1, characterized in that:
a first tapered portion and a second tapered portion are continuously provided with the injection port as an end portion, in predetermined positions of an inner wall of the paint injection nozzle which correspond to the tip portion and the tapered portion of the needle, respectively;
the first tapered portion is a tapered portion whose diameter decreases from the injection port toward the interior of the paint injection nozzle; and
the second tapered portion is a tapered portion whose diameter increases from a boundary between the second tapered portion and the first tapered portion toward the interior of the paint injection nozzle.

8. A painting device according to claim 1, characterized in that the needle is urged in a direction for closing the injection port by means of an elastic member, the elastic member being constructed from a combination of plural elastic members having different elastic moduli.

9. A painting device according to claim 8, characterized in that the elastic member is a spring, the spring being constructed from plural springs having different spring moduli.
